(19) United States
(12) Patent Application Publication
(10) Pub. No.: US 2006/0120087 A1
(43) Pub. Date: Jun. 8, 2006

(54) Structure disassembly-type lamp shade

(76) Inventor: Wen-Chang Wu, Sioushuei Township (TW)

Correspondence Address: TROXELL LAW OFFICE PLLC;SUITE 1404, 5205 LEESBURG PIKE, FALLS CHURCH, VA, 22041, US

(21) Appl. No.: 11/000,888

(22) Filed: Dec. 2, 2004

(51) Int. Cl. F21V 1/06; F21V 1/16; F21V 11/00

(52) U.S. Cl. 362/352; 362/357

(57) ABSTRACT

An improved structure disassembly-type lamp shade comprised of a top ring; a bottom ring; a lamp shade, the upper and lower end surfaces of which are respectively disposed on the top ring and the bottom ring; and support elements braced between the top and bottom rings. A plurality of insertion blocks and are disposed along the physical circumferences of the said top ring and bottom ring which provide for the respective insertion of the upper and lower extremities of the support elements between the top and bottom rings. The support elements are stuck together a ornamental cloth respectively, and having resilience. When the support elements are inserted or insert, the support elements distend arcuately along the lamp shade exterior sides, and then push the said arcuately position to bows inward against the surface of the lamp shade. Furthermore, a plurality of inelastic fabric strips are respectively disposed in alignment with the top and bottom ring insertion block positions along the lamp shade interior surface. Since the inelastic fabric strips provide the lamp shade to reduce its twist, and applied the same length of inelastic fabric strips which enable the lamp shade between the top and bottom rings are fabricated at the same height. As such, the invention can achieve the disassembly and fabrication fast, and can be arisen the quality, and having the exterior beauty of the lamp shade.

### BACKGROUND OF THE INVENTION

1) Field of the Invention

The invention herein relates to an improved structure disassembly-type lamp shade in which a plurality of insertion blocks are disposed along the physical circumferences of the top ring and the bottom ring to provide for the respective insertion of the upper and lower extremities of the said support elements between the top and bottom rings. He support elements are stuck together a ornamental cloth respectively, and having resilience. When the support elements are inserted or insert, their support elements distend arcuately along the lamp shade exterior sides, and then push the said arcuately position to bows inward against the surface of the lamp shade, in the meantime, the lamp shade can be ornamented with the ornamental cloth of the support elements. Furthermore, a plurality of inelastic fabric strips are respectively disposed in alignment with the top and bottom ring insertion block positions along the lamp shade interior surface. Since the inelastic fabric strips provide the lamp shade to reduce its twist, and applied the same length of inelastic fabric strips which are based on making up the same range of lamp shade from the top ring to bottom ring. As such, the invention can achieve the disassembly and fabrication fast, and can be arisen the quality, and having the beauty of the lamp shade.

2) Description of the Prior Art

In prior art lamp shades, the support rods are typically conjoined between the top ring and the bottom ring in a permanent state and, as such, since the lamp shade cannot be collapsed when packaged, the product occupies a considerably larger space, resulting in increased storage and shipping dimensions as well as the associated higher costs. Therefore, the applicant of the invention herein researched and developed a kind of lamp shade structure that can be dismantled, specifically the “Disassembly-Type Lamp Shade Structure (2)” filed under U.S. Pat. No. 6,517,220 consisting of sleeve mounts 21 disposed on the lamp shade bottom ring 2 and frame members 3 having insert posts 32 at their bottom extremities that enable the insertion of the frame members 3 insert posts 32 into the sleeve mounts 21 as well as the insertional retaining of the support member 3 in the top ring 1 and, as such, the top ring 1, the bottom ring 2, and the support rods 3 are durably assembled into a single structural entity. However, such an assembly approach, because the support rods 3 are of metal construction and, furthermore, situated at the lamp shade interior surface, requires the removal of lamp shade internal section, and if the lamp shade is a double layer-type lamp shade, then the inner and outer layer of the lamp shade must first be separated before the support members 3 removal is possible, resulting in the shortcoming of troublesome difficulty during assembly and disassembly.

### BRIEF DESCRIPTION OF THE DRAWINGS

FIG. 1 is an exploded drawing of the invention herein.

FIG. 1-A is a partially magnified drawing of FIG. 1-A.

FIG. 2 is an isometric drawing of the invention herein.

FIG. 2-A is a partially magnified drawing of the conjoinment section in FIG. 2.

FIG. 2-B is a partially magnified drawing of the conjoinment section in FIG. 2.

FIG. 2-C is a partially magnified drawing of the conjoinment section in FIG. 2.

FIG. 3 is an orthographic drawing of the invention herein.

FIG. 3-A is a partially magnified cross-sectional drawing of FIG. 3.

FIG. 3-B is a partially magnified cross-sectional drawing of FIG. 3.

FIG. 4 is an orthographic drawing of the invention herein.

FIG. 4-A is a partially magnified cross-sectional drawing of the conjoinment section in FIG. 4.

FIG. 4-B is a partially magnified cross-sectional drawing of the conjoinment section in FIG. 4.

FIG. 5 is an isometric drawing of the support element before posturing.

FIG. 6 is an isometric drawing of the support element before surrounding by the fabric surface.

FIG. 6-A is a partially magnified drawing of FIG. 6.

FIG. 6-B is a partially magnified drawing of FIG. 6.

### DETAILED DESCRIPTION OF THE PREFERRED EMBODIMENTS

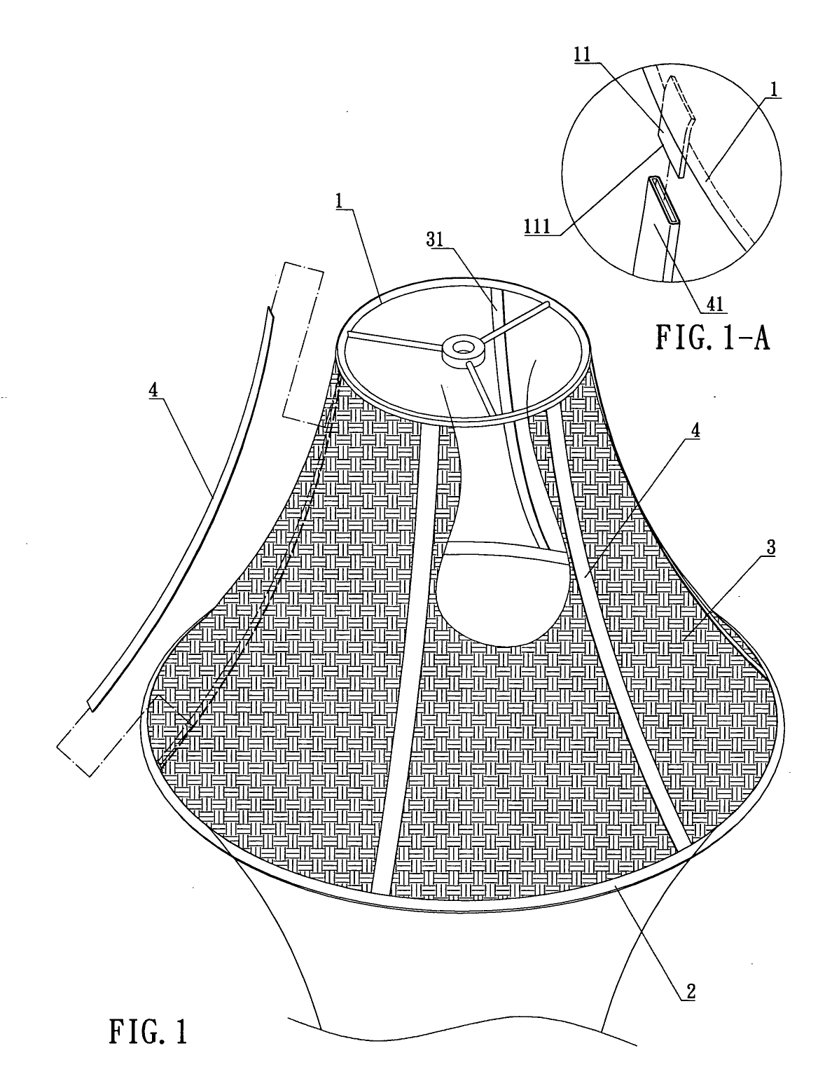

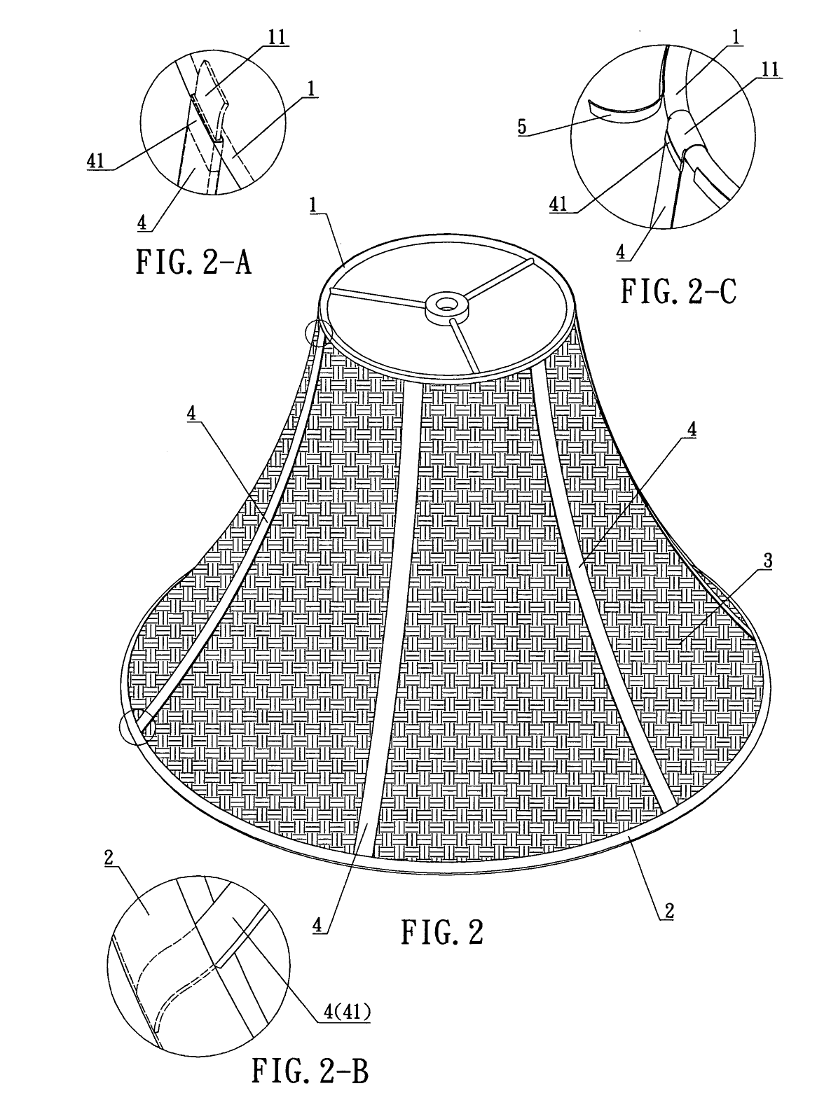

Referring to FIG. 1 and FIG. 2, the structural arrangement of the invention herein, the present invention is comprised of a top ring 1, a bottom ring 2 having a larger diameter than the top ring 1, a lamp shade 3, and support elements 1 between the top and bottom rings 1 and 2, wherein:

A plurality of insertion blocks 11 are disposed along the physical circumference of the said top ring 1, the said insertion block 11 bottom edges 111 extending downward from the exterior side of the lamp shade 3 (FIG. 1-A).

Referring to FIGS. 2A˜C, aligned with the top ring insertion block 11 positions, insertion blocks 21 on the said bottom ring 2 extend upward from the exterior side of the lamp shade 3 fabric surface, thereby providing for the respective insertion of the upper and lower extremities of the support elements 4 between the top and bottom rings 1 and 2, then using a lace fabrics 5 stick and surround the top ring and bottom ring which including the insertion blocks 21.

Referring to FIG. 1 and FIG. 2, constituting the upper and lower end surfaces of the lamp shade 3, a plurality of inelastic fabric strips 31 are respectively disposed on the top ring 1 and the bottom ring 2 and, furthermore, in alignment with the top and bottom ring insertion blocks 11 and 21 positions along the lamp shade 3 interior surface; as such, since the inelastic fabric strips 31 lack flexile characteristics, after the lamp shade 3 is propped open, the fabric surface tension between the top and bottom rings 1 and 2 is significantly reduced and since each inelastic fabric strip 31 is also of an equal length, the entire surrounding fabric surface is of an identical length following the propping open of the lamp shade 3.

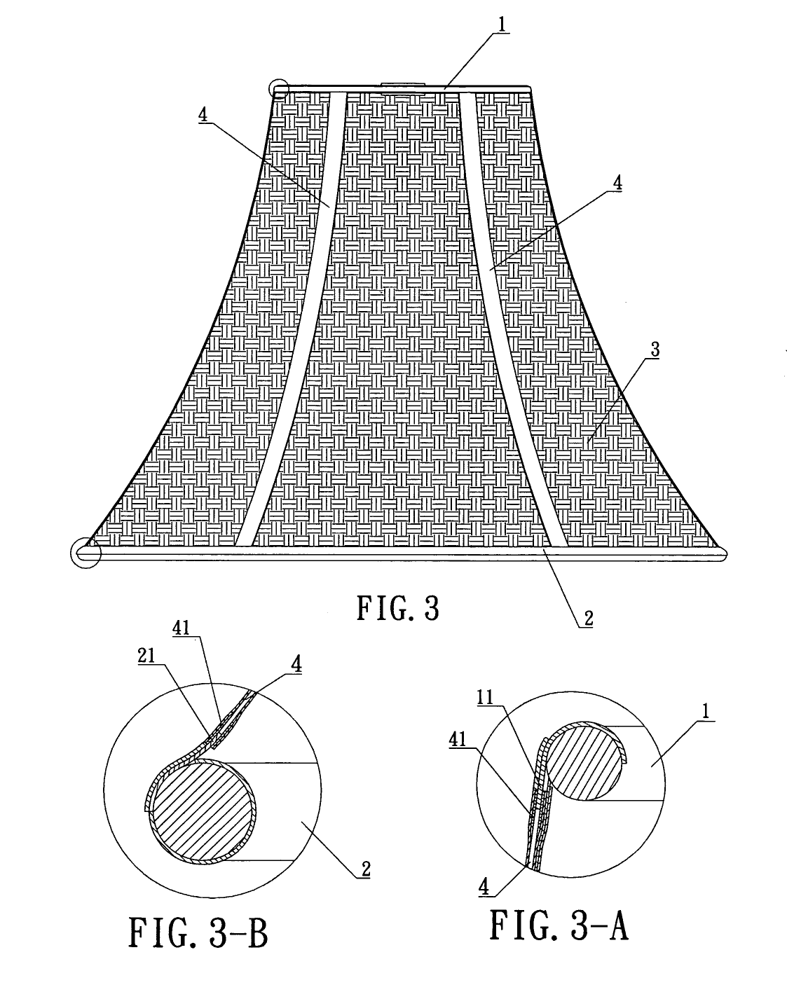

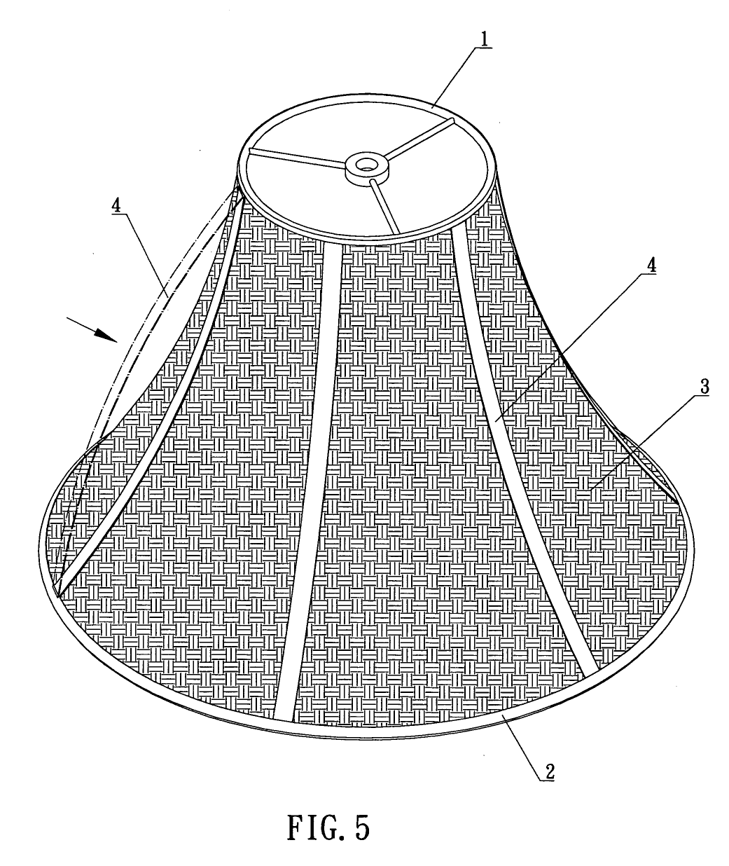

Referring to FIG. 3 and FIGS. 3A˜B, an insertion sleeve 41 is preinstalled onto the upper and lower extremities of the said support elements 4, each insertion sleeve 41 capable of the respective admittance of the insertion blocks 11 and 21 on the top ring 1 and the bottom ring 2 and, furthermore, when the said support elements 4 are inserted, their element bodies distend arcuately along the lamp shade 3 exterior sides (as shown in FIG. 5) and the accompanying inward tensile pressure of the arcuately distended support elements 4 is applied against the lamp shade 3 superficial edging as the top and lower extremities brace the top and bottom ring 1 and 2 and, furthermore, when the support elements 4 are postured against the lamp shade 3 superficial edging, they at the same time serve as ornamental cloth along the superficial edging of the lamp shade 3, thereby achieving the coincident capability of reinforcement and the superficial edging ornament of the said lamp shade 3.

As such, since the support elements 4 provide for structural reinforcement while also serving as ornamental lining and, furthermore, following the removal of the support elements 4, the lamp shade 3 can be disassembled, assembly and disassembly is conveniently simple and rapid; additionally, after removing the support elements 4, the top and bottom rings 1 and 2 as well as the lamp shade 3 can all be dismantled into a single flat planar arrangement to reduce storage and shipping dimensions and thereby effectively decreasing shipping cost.

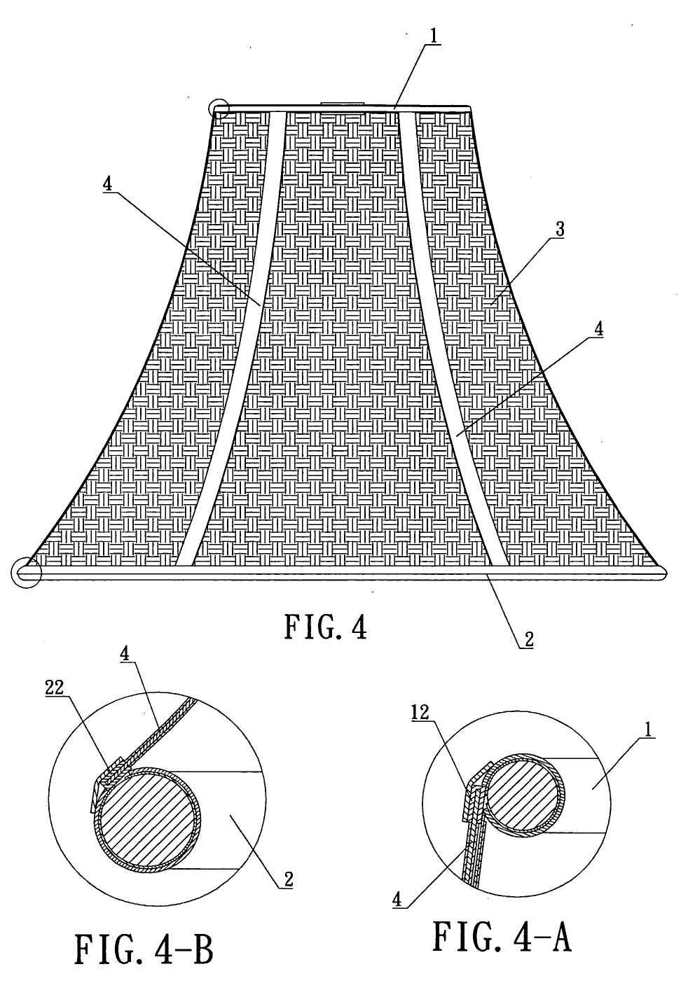

Referring to FIG. 4 and FIGS. 4A˜B, a plurality of insertion blocks 11 and 21 are disposed along the physical circumferences of the said top ring 1 and bottom ring 2, and the upper and lower extremities of matching support elements 2 are directly admitted into the insertion blocks 11 and 21; furthermore, when the said support elements 4 are inserted, their element bodies distend arcuately along the lamp shade 3 exterior sides and the accompanying inward tensile pressure of the arcuately distended support elements 4 is applied against the lamp shade 3 superficial edging as the top and lower extremities brace the top and bottom ring 1 and 2 and, furthermore, when the support elements 4 are postured against the lamp shade 3 superficial edging, they at the same time serve as ornamental cloth along the superficial edging of the lamp shade 3, thereby also achieving the coincident capability of reinforcement and the superficial edging embellishment of the said lamp shade 3.

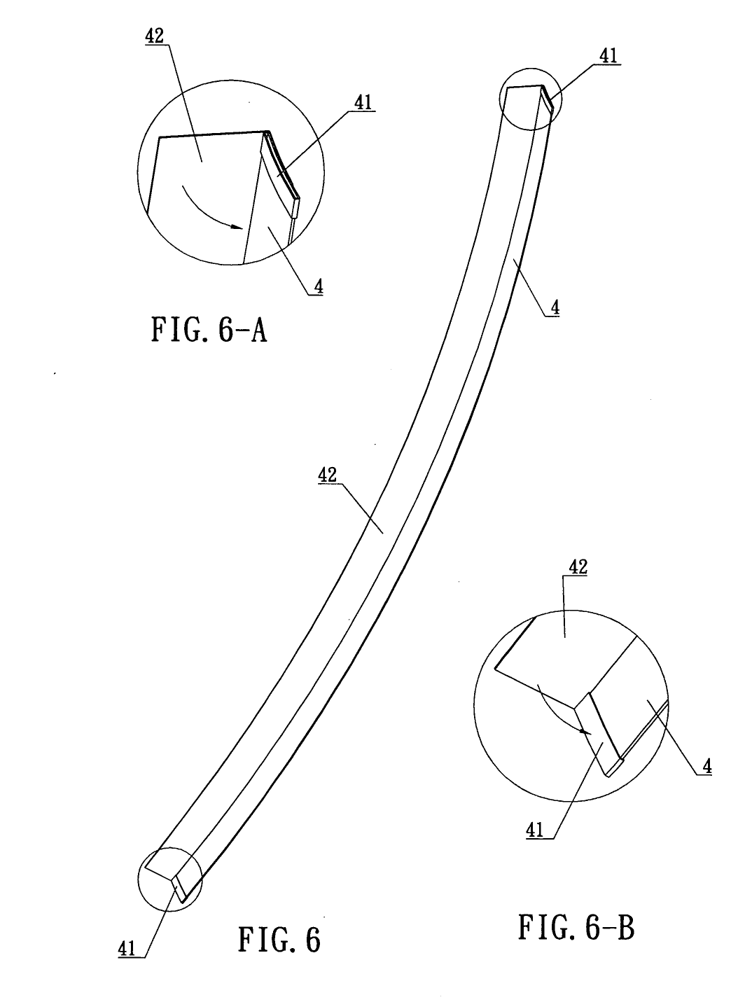

Referring to FIG. 6 and FIGS. 6A˜B, the support elements 4 are covered by an ornamental cloth 42 which can be provided the different pattern to fit the lamp shade pattern.

1. An improved structure disassembly-type lamp shade comprised of a top ring; a bottom ring; a lamp shade, the upper and lower end surfaces of which are respectively disposed on the said top ring and the said bottom ring; and support elements 1 braced between the said top and bottom rings, wherein;
a plurality of insertion blocks are disposed along the physical circumferences of the said top ring and the said bottom ring;
a plurality of inelastic fabric strips are respectively disposed in alignment with the top and bottom ring positions of the said insertion block along the interior surface of the said lamp shade;
the support elements have the resilience, and cover an ornamental cloth; the two sides respective insert the said insertion blocks on the top and bottom ring to extend the lamp shade;
as such, applying the resilient support elements are inserted, their element bodies distend arcuately along the lamp shade exterior sides and the accompanying inward tensile pressure of the arcuately distended support elements is applied against the lamp shade superficial edging as the top and lower extremities brace the top and bottom ring, and the inelastic fabric strips can avoid twisting the lamp shade after the lamp shade is extended.

2. As mentioned in claim 1 of the improved structure disassembly-type lamp shade of the invention herein, the said support elements have insertion sleeves preinstalled onto their upper and lower extremities such that each said insertion sleeve is capable of the respective admittance of the said insertion blocks on the said top ring and the said bottom ring to thereby brace the said top and bottom rings at their upper and lower extremities.

3. As mentioned in claim 1 of the improved structure disassembly-type lamp shade of the invention herein, the said top ring as well as the said bottom ring have a plurality of insertion slots disposed along their physical circumferences and, furthermore, the top and bottom extremities of the said support elements are directly admitted into the said insertion slots.

4. As mentioned in claim 1 of the improved structure disassembly-type lamp shade of the invention herein, the plurality of inelastic fabric strips are same length that enable the lamp shade between the top and bottom rings are fabricated at the same height.

5. As mentioned in claim 1 of the improved structure disassembly-type lamp shade of the invention herein, the ornamental cloths can be changed to fit the lamp shade's pattern.
